(19) United States
(12) Patent Application Publication
(10) Pub. No.: US 2007/0288359 A1
(43) Pub. Date: Dec. 13, 2007

(54) PROCESSING OF CREDIT APPLICATIONS

(76) Inventors: Susan Amadio, Etobicoke (CA); Theresa Breen, Bedford (CA); Steve Kai-Yee Chan, North York (CA); Paula Christiaans, London (CA); Carole Cooper, Mississauga (CA); Michael Cummins, Toronto (CA); Greg Fedyk, Whitby (CA); Glen Giacomelli, Nobleton (CA); Craig Kimber, Winona (CA); Angela Nyhuis, Burlington (CA); Daniel Herbert Ostler, Ajax (CA); Ashish Pandita, Richmond Hill (CA)

Correspondence Address: TORYS LLP, 79 WELLINGTON ST. WEST, SUITE 3000, TORONTO, ON, M5K 1N2, CA

(21) Appl. No.: 11/736,820

(22) Filed: Apr. 18, 2007

Related U.S. Application Data
(60) Provisional application No. 60/793,341, filed on Apr. 18, 2006.
(60) Provisional application No. 60/746,559, filed on May 5, 2006.

(51) Int. Cl. G06Q 40/00

(52) U.S. Cl. 705/38

(57) ABSTRACT

Systems, methods, computer programming, and graphical user interfaces adapted for enabling creditors to provide prospective debtors with multiple credit opportunities and the ability to act on them, either separately or in various combinations. The credit opportunities may be identified using, in whole or in part, consideration of financial histories of the prospective debtors with the creditor making the plurality of credit offers, and/or the financial history(ies) of the prospective debtors with other creditors.

This application claims the benefit of (i) provisional application no. 60/793,341 filed 18 Apr. 2006 and (ii) provisional application no. 60/746,559 filed 5 May 2006, which applications, including all appendices and attachments, are incorporated herein by reference.

### FIELD OF THE INVENTION

The invention relates to the identification and exploitation of consumer and commercial credit opportunities. More particularly, the invention provides systems, methods, computer programming, and graphical user interfaces useful for such activities.

### SUMMARY OF THE INVENTION

In various aspects, the invention provides systems, methods, computer programming media, and graphical user interfaces adapted for enabling creditors to provide prospective debtors with multiple credit opportunities and the ability to act on them, either separately or in various combinations. The credit opportunities may be identified using, in whole or in part, consideration of financial histories of the prospective debtors with the creditor making the plurality of credit offers, and/or the financial history(ies) of the prospective debtors with other creditors.

In one aspect, for example, the invention provides systems useful for the automated identification of credit opportunities, including particularly credit sales opportunities, the systems comprising data processors and computer programming adapted to cause the data processors to access data representing information identifying prospective debtors and, using at least some of the accessed data, access in memory associated with the data processors data representing information related to financial histories of the prospective debtors with the creditor. The programming is further adapted to cause the processor to access, in the same or other memory, data representing information related to a financial history of the prospective debtor with at least one other creditor, and, using either or both financial histories, to determine a plurality of forms of credit to be offered by the creditor to the prospective debtor. Preferably, the system outputs information relating to the one or more forms of credit to be offered to the prospective debtor, for review and optionally for acceptance or other processing.

In some embodiments, systems according to the invention make use of multiple sources for credit history(ies). Such sources can include, for example, single and/or multiple internal and external sources, alone or in any suitable combinations.

The forms of credit offered may be of any type. For example, the forms of credit may include consumer and/or business credit card arrangements, commercial and/or consumer loans, revolving lines of credit, account overdraft protection arrangements suitable for use in conjunction with deposit and other accounts, mortgages, and other forms of secured or unsecured loans. Such forms of credit may be offered in the alternative, and multiple variations of each of the forms may be offered. For example, multiple commercial or consumer loans may be offered, at varying interest rates and amortizations; or multiple credit card offerings may be made, including differing terms such as annual fees, travel or other rewards, and varying interest rates.

Memories are associated with data processors when the memories are under the control of the processors or related common operating systems, or are commonly operated or maintained, as for example when both are operated as part of a single computer, or as parts of a computer system controlled by a single operator, as for example a bank or other credit institution.

In another aspect, the invention provides systems useful for the automated identification of credit opportunities, the systems comprising data processors and computer programming adapted to cause the data processors to access data representing information related to the financial status, financial histories, or other considerations related to prospective debtors, and, using such data, to pre-approve or otherwise identify offerings to be made by a creditor of multiple forms of credit to each of the prospective debtors. The financial histories of the prospective debtors may be with respect to the creditor making the multiple offers or with respect to third parties. The data processors may be operated by, or otherwise controlled by or associated with, the creditor making the multiple processors, or others.

In another aspect, the invention provides systems useful for the automated identification of credit opportunities, the systems comprising data processors and computer programming adapted to cause the data processors to access in memory associated with the data processor data representing information related to an application of an applicant for credit to be granted by the creditor; using at least some of the accessed data, access in the same or other memory associated with the data processor data representing information related to a financial history of the applicant with the creditor; using at least some of the accessed data, access in the same or other memory data representing information related to a financial history of the applicant with at least one other creditor; using the data representing the financial history of the applicant with the creditor and the data representing the financial history of the applicant with the at least one other creditor, determine one or more forms of credit to be offered by the creditor to the applicant; and output for review by the applicant data representing information relating to the plurality of forms of credit to be offered to the applicant.

In another aspect, the invention provides user interface display screens adapted for the presentation to and acceptance by prospective debtors of multiple credit offers made by one or more creditors. In one embodiment of such aspect, for example, the invention provides computer programming media adapted for causing a data processor to provide output signals useful for causing a computer display to present a graphical user interface screen useable by a user in controlling the same or another processor in the automated identification of credit opportunities, the display screen comprising at least one output field and a plurality of input fields. The at least one output field is adapted for identifying at least one of a plurality of credit offers offered by one or more creditors to a prospective debtor, whereby a plurality of credit offers offered by the creditor(s) to the prospective debtor are identified to a user of the computer display, each credit offer being identified by the display of at least a type of credit and a credit amount. The plurality of input fields usable by a user of the computer display in conjunction with an input device for inputting data indicating at least a partial acceptance of at least a part of one of the plurality of credit offers. In a particularly advantageous variation of such an embodiment, the computer programming is further adapted for causing the same or another processor to deduct an amount indicated by the user in the at least partial acceptance from a total amount of credit offered and/or an amount used by the processor in identifying at least one of the plurality of credit offers.

In various aspects the invention provides systems, methods, computer programming, and graphical user interfaces useful in implementing each of the foregoing aspects of the invention, and the other functions and features disclosed herein.

### BRIEF DESCRIPTION OF THE FIGURES

The invention is illustrated in the figures of the accompanying drawings, which are meant to be exemplary and not limiting, in which like references are intended to refer to like or corresponding parts, and in which:

FIG. 1 is a schematic diagram of a system architecture suitable for use in implementing the invention.

FIG. 2 is a schematic flow diagram of an embodiment of a process suitable for use in implementing the invention.

FIGS. 3a-3c are schematic diagrams of an embodiment of a graphical user interface screen in accordance with the invention.

### DETAILED DESCRIPTION OF ILLUSTRATIVE EMBODIMENTS

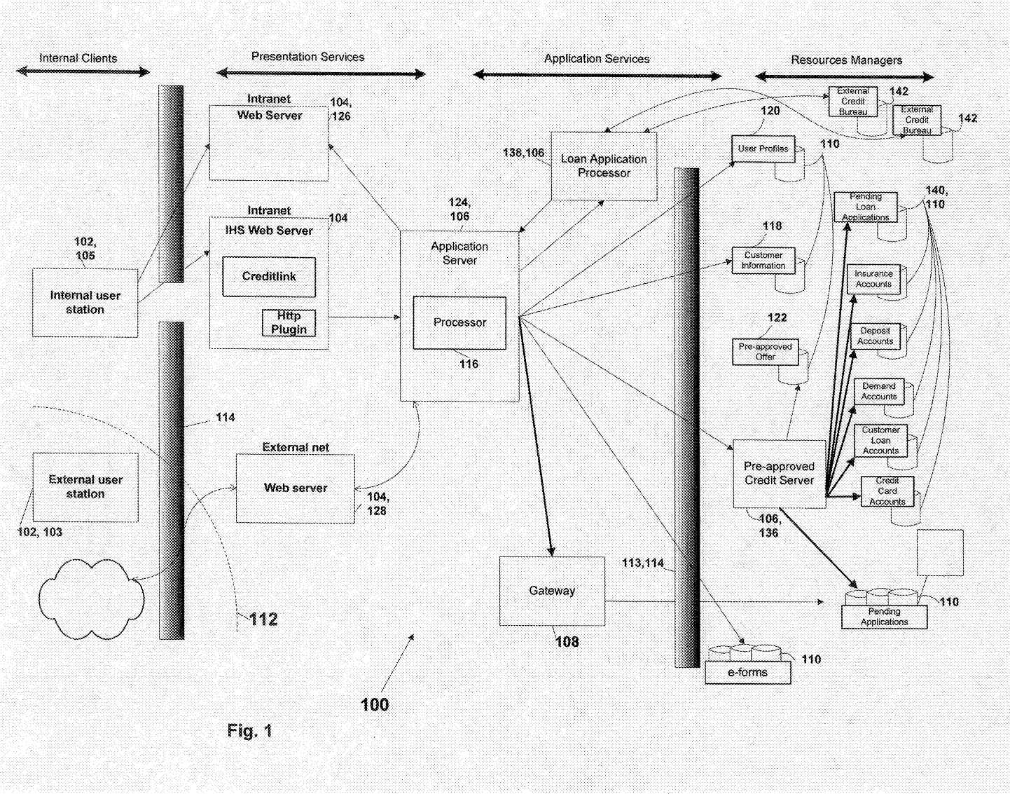

FIG. 1 provides a schematic diagram of a system architecture suitable for use in implementing an embodiment of the invention. System 100 is useful for, among other purposes, the automated identification of credit opportunities and the granting of credit, and other credit processing functions, and may be operated and/or controlled by or on behalf of, for example, a bank, credit union, or other financial or credit-offering and/or—issuing institution seeking to offer credit to prospective debtors such as individuals, businesses, and/or other potential parties to consumer- and/or commercial secured or unsecured loans.

As will be appreciated by those skilled in the relevant arts, once they have been made familiar with this disclosure, in various embodiments the invention is especially well suited for use by banks, credit unions, and other parties in the business of providing credit and credit opportunities to consumers, businesses, and other prospective debtors. Thus in credit opportunities offered in accordance with the invention can include credit sales opportunties.

Credit sales, as will be understood by those skilled in the relevant arts, include transactions in which credit is offered or extended to a prospective debtor in return for a consideration, such as the payment of interest and/or other fees.

Credit opportunities identified, and forms of credit offered, by such creditors, including for example credit sales opportunities, can include any suitable forms of loans or other credit arrangements, including for example consumer and/or business credit card arrangements, commercial and/or consumer loans, revolving lines of credit, account overdraft protection arrangements suitable for use in conjunction with deposit and other accounts, mortgages, and other forms of secured or unsecured loans.

In the embodiment shown in FIG. 1, system 100 comprises user stations 102, network servers 104, application servers 106, gateway 108, and databases 110.

User stations 102 are adapted for providing output to and accepting or otherwise receiving input from users of internal stations 105 and external stations 103. Users of internal stations 105 (i.e., internal users) can include users authorized by the creditor to access its system 100 and data controlled by the creditor, such as officers or other employees of a bank, credit card issuer, or other financial institution, including for example branch staff, financial advisors (FAs), and call center operators. Data input by such users can include, for example, data related to prospective debtors and their financial histories with the creditor and others, including for example data useful in the completion and consideration of credit applications; and command signals adapted for controlling system 100 in implementing the processes described herein. Output provided to such users can include, for example, data useful in the review, acceptance, and other processing of credit offers.

Users of external stations 103 (i.e., external users) can include for example potential debtors such as customers or clients of a bank or other lending institution who access the system 100 over a network 107 such as the internet, other public and/or private communications network, or combinations thereof. Data input by and output provided to such external users can include, for example, data related to credit applications, review of credit offers, and the control of credit applications, acceptance, and other processes.

Both internal and external user stations 102 may comprise any terminals or other user interface systems suitable for use in accomplishing the purposes implementing the functionality described herein, including for example personal computers, work stations, and dumb terminals comprising suitable keyboards, pointing devices, displays, and other input/output devices; modems, network hardware and other communications devices; and processors as appropriate. A wide variety of such systems and devices are now available commercially, and will doubtless hereafter be developed. Such stations may include privately-accessed systems such as computers operated by banks or other businesses, home computers used by consumers or other individuals, and machines accessible by the public, such as point of sale devices, including for example automatic banking (or teller) machines, retailer systems, and the like.

External stations 103 may be isolated from portions of system 100 controlled by the creditor by suitable firewalls 112 and/or other security arrangements. Internal firewalls 114 may be employed in segregating various internal systems, to minimize detrimental effects of various forms of systems failure. In the embodiment shown in FIG. 1, portions of system 100 to the right of firewall 112 and to the left of firewall 113 may be considered to be operated or controlled by or on behalf of the creditor.

Network servers 104 can provide interface services, including for example firewalls and other security measures; protocol and language translations; and queuing and other traffic control functions in receiving input from and providing output to user stations 102 and controlling processes performed by the various components of system 100. One or more of servers 104 may be adapted to perform a wide variety of general- or special-purpose communications and control functions in governing the workload of application servers 106. Any computers or other data processors, including suitable operating software, suitable for use in accomplishing the purposes implementing the functionality described herein will serve. A wide variety of such systems and devices are now available commercially, and will doubtless hereafter be developed.

Application servers 106 can provide processors and software, including suitable applications and operating systems, adapted for performing credit processing functions such as accessing, processing, and reviewing data related to prospective debtors; receiving, processing, storing, and accessing credit applications; identifying credit opportunities; and providing outputs related to offering and processing acceptance of credit offers; and other functions disclosed herein. Any computers or other data processors, including suitable operating software, suitable for use in accomplishing the purposes implementing the functionality described herein will serve. A wide variety of such systems and devices are now available commercially, and will doubtless hereafter be developed.

Gateway(s) 108 can provide security and communications links between the various user stations, application servers, and databases of system 100. They can provide, for example, firewall protection, encryption/decryption functions, and translation between various protocols and languages. For example, gateway(s) 108 can provide translation or reformatting of data between TCP/IP and internal bank or financial service protocols, including for example proprietary protocols or public-domain protocols such as FIX. Any computers or other data processors, including suitable operating software, suitable for use in accomplishing the purposes implementing the functionality described herein will serve. A wide variety of such systems and devices are now available commercially, and will doubtless hereafter be developed.

Databases 110 can provide for the storage, accessing, and management of data useful in implementing the processes described herein. Any volatile or persistent memory devices, and supporting operating software, implementing any suitable data structures, suitable for use in accomplishing the purposes described herein will serve. For example, either a dedicated, specially designated computer with an associated memory, or a single data file on a general-purpose computer, will serve. A wide variety of such systems and devices are now available commercially, and will doubtless hereafter be developed.

System 100 is operable for identifying and facilitating acceptance of credit offers, and other credit opportunities, in accordance with the invention. The various components 102, 104, 106, 108, 110, etc., of system 100 are adapted for receiving, forwarding, storing, accessing, and otherwise processing data signals representing information and commands useful in accomplishing the functions described herein.

As will be understood by those skilled in the relevant arts, the various aspects of the invention may be implemented in a wide variety of forms in different embodiments. Any system and/or programming architecture or other arrangement compatible with the purposes disclosed herein will serve. For example, system 100 as shown in FIG. 1, or a single PC with public network access such as the Internet, for use in accessing external credit-checking databases and information, and a wide variety of architectures in between, will serve.

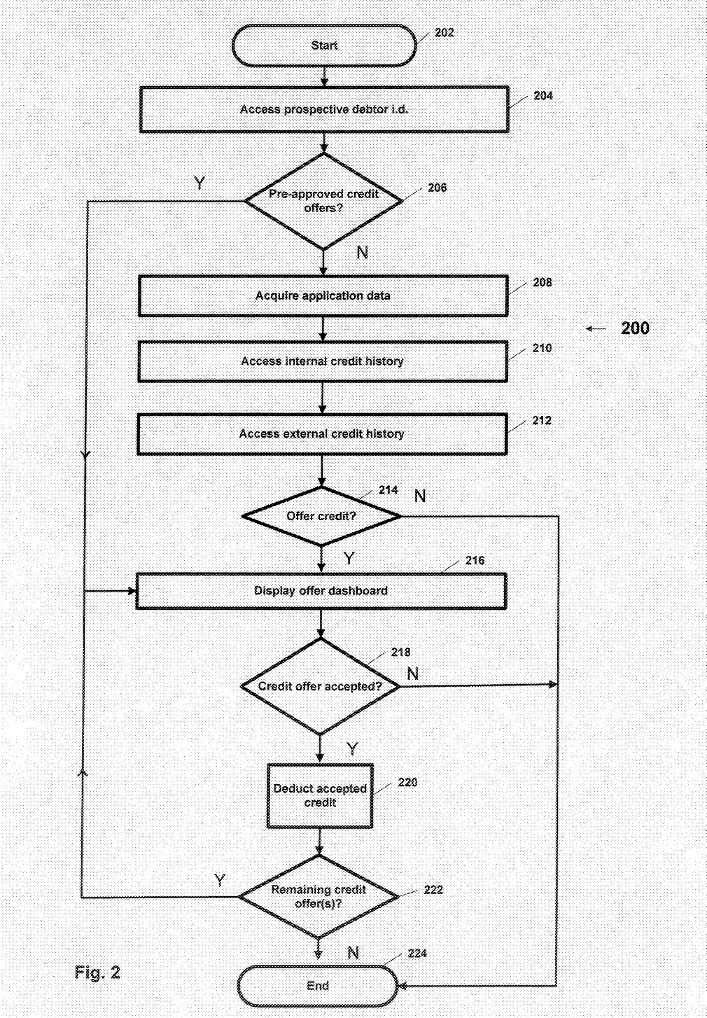

FIG. 2 is a schematic flow diagram of an embodiment of a process 200 suitable for use in implementing the invention. Process 200 shown in FIG. 2 is suitable for implementation using automatic data processing equipment according to any of the various embodiments disclosed herein, including for example system 100 of FIG. 1 and various components and/or variations thereof. Process 200 shown in FIG. 2 is suitable for implementation using any appropriate general- or special-purpose hardware, firmware and/or software, any of which may be provided with or in the form of computer programming media adapted to cause the one or more processors comprised by such system to perform the various disclosed herein, as for example electromagnetically-recorded compilations of programming structures written in any of a wide variety of suitable programming languages. Such programming languages can comprise, for example, any one or more of JAVA, any of the C variants, including C+ and C++, FORTRAN, COBOL, PASCAL, and BASIC. A wide variety of suitable languages are now available, and will doubtless hereafter be developed.

Process 200 can begin at 202 with preliminary processes of user log-on and invocation or starting of the credit-offering application. For example, a user of an internal user station 105, such as a financial advisor or other agents or representatives of a credit-offering institution can, using suitable input devices such as a keyboard and/or pointing device in conjunction with an interactive graphical user interface and a suitably-configured operating system, issue command signals adapted for causing intranet server 126 to provide input prompts for a user name and password, enter input data representing a user name and password in response to such prompts, and cause server 104 to access user profile database 120 via application server 124 to confirm the user's identity and authorize system access. Thereafter the user can issue suitable command signals to cause application server 124 to start a credit-offering application in accordance with the disclosure herein.

For example, a customer of a bank or other lending institution who has expressed an interest in obtaining one or more forms of credit from the lending institution can be interviewed by a loan officer or other customer service representative of the institution, who can use the user station 105 to invoke the credit-offering application of the embodiment.

Similarly, external network server 128 can be accessed by a user of an external station 103 to perform similar log-on and application-invocation processes, optionally with varying and in particular reduced levels of authorized access to data and internal credit institution program applications. Such a user might be, for example, a customer or prospective customer of a lending institution applying for or otherwise investigating the possibility of obtaining credit from the lending institution.

As part of the log-on and application invocation processes, user profiles, preferences, and identity authentication data stored in a user profile data base 120 may be accessed.

Once the user of a user station 102 has invoked and if necessary established authority to access the credit-offering application, process 200 can continue at 204 with the accessing, by a processor such as processor 116 of system 100, of data identifying a prospective debtor. For example, a user of an internal user station 105 can issue command signals adapted for causing processor 116 to access data stored in customer information database 118 identifying a potential debtor of interest to the user. Such a potential debtor can include, for example, a customer of a bank being interviewed by a bank officer.

In some embodiments, an external user not associated with a lending or other credit-offering institution can also obtain limited information. For example, such an external user may be a customer who uses an external user station 103 to cause processor 116 to access information related to, for example, the external user, or to limited information relating to another individual or business associated with the external user, in a customer information database 118. Such limited information may preferably be limited to non-personal information, or in some embodiments, be limited to an identification of individual(s) or business(es) that are associated borrower(s).

Data stored in database 118 identifying a prospective debtor can include any information useful in identifying the prospective debtor or otherwise useful in considering, offering, and issuing and/or administering credit or a credit account, including for example a prospective debtor's name, address, contact information, social security or social insurance number, account numbers and balances, and any relevant history relative to the credit-offering institution operating or otherwise controlling system 100.

At 206, processor 116, either in response to a command issued by a user of a user station 102 or automatically, i.e., without further input from the user, can access a pre-approved credit data base 122, as for example through interaction with pre-approved offer server 136, to determine whether any pre-approved credit offers have been authorized for the prospective debtor identified at 204. For example, a creditor controlling processor 116 can, prior to accessing a database 118, cause a pre-approved offer server 136 to identify a prospective debtor such as an existing bank customer in response to input received from an internal or external user; determine whether, based on the prospective debtor's current financial status, including for example current deposits, outstanding loan or debt status, revolving credit rights and obligations, etc., and any other factors the creditor deems relevant, the creditor wants to pre-approve one or more lines of credit, consumer loans, credit cards, mortgages, etc., to be offered to the prospective debtor; and store data relating to such pre-approved offers in the database 122. One or more such offers may be prepared using, for example, data stored in dedicated databases 140 or other data sources provided for storing data related to the prospective debtor's past, current or pending accounts with the lending institution, and making such data available to the processor 116.

Thereafter, when for example a user has invoked the credit-offering application and identified a prospective debtor, processor 116 can automatically query server 136 and access the database 122 and, if any such pre-approved offers exist, retrieve any relevant data and present to the user output data identifying any such pre-approved credit offers by causing them to be displayed at the corresponding user station 102. Preferably the offers are displayed in such fashion as to allow the prospective debtor to accept or otherwise act on any one or more of the presented offers, if the prospective debtor so desires.

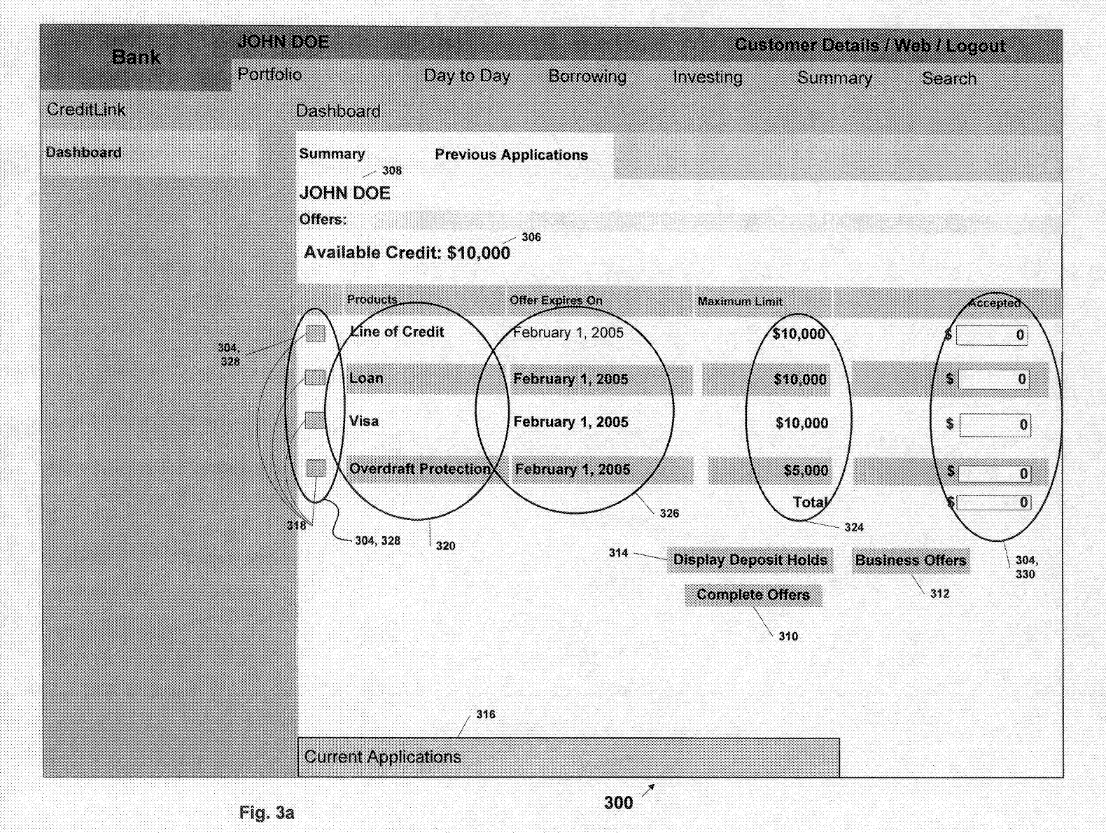

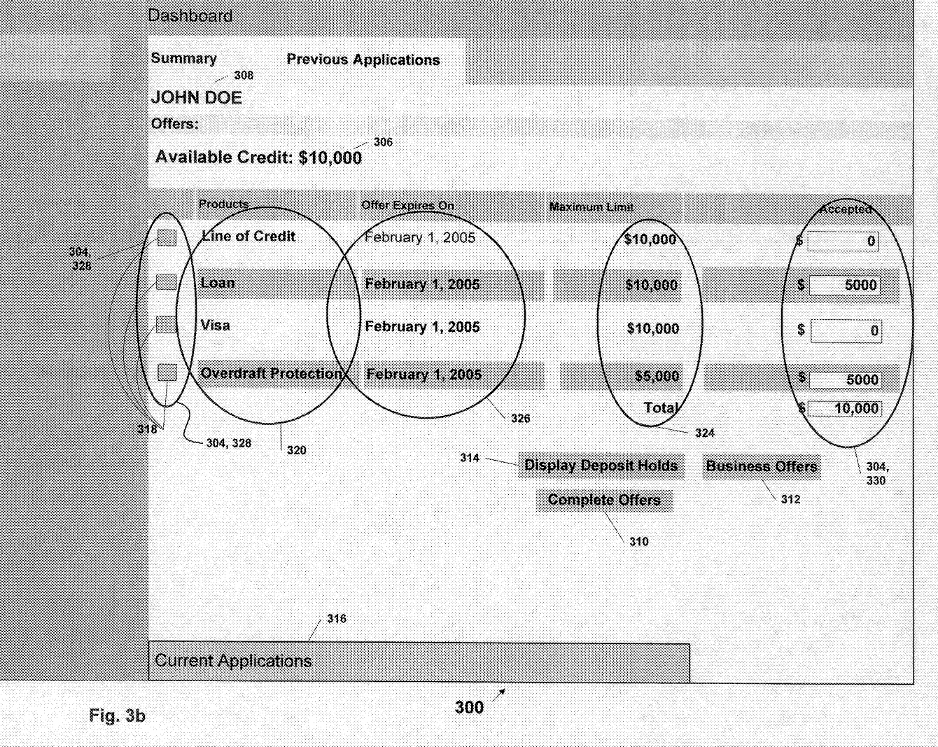

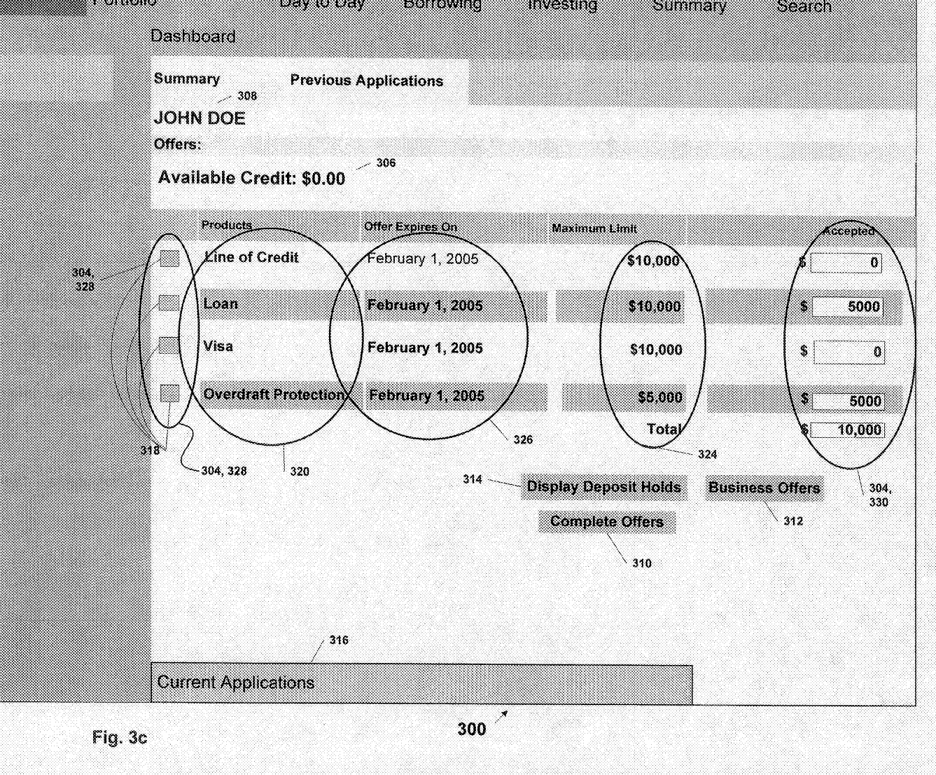

For example, as shown in FIG. 2, at 216 processor 116, and/or pre-approved offer server 136, can cause a display offer dashboard user interface screen to be displayed on the user station 102 from which the prospective debtor was identified. An example of such a display screen is shown in FIG. 3.

In the embodiments shown in FIGS. 3a-3c, offer display dashboard 300 comprises one or more offer display field(s) 302 and one or more acceptance input field(s) 304. Display field(s) 302 can display any desired information identifying the offer(s) made, typically including for example the type 320 of offer(s) extended and a credit amount 324 associated with each offer. In the example shown in FIG. 3a, display field 302 comprises four offer lines 318, corresponding to offers for a type 320 “line of credit” in the maximum amount 324 of $10,000; a type 320 “personal loan” in the maximum amount 324 of $10,000; a type 320 “visa” credit card account with a limit amount 324 of $10,000; and a type 320 “overdraft protection” account in the maximum amount 324 of $5,000. In the embodiment shown, field 302 further comprises offer expiration dates 326 indicating a last date upon which the offer(s) can be accepted, i.e., after which the offers are withdrawn.

As will be understood by those skilled in the relevant arts, additional information including, for example, interest rates, payment schedules, loan-term length, and other items can be displayed, either as part of field(s) 302 or via devices such as hypertext links associated with any one or more of the descriptors included in the field(s) 302.

Acceptance field(s) 304 comprise fields adapted for user input of indicator(s) of acceptance of the offer(s) displayed. In various embodiments of the invention, acceptance can be either full or partial, in accordance with the needs and desires of the creditor. For example, acceptance fields 304 can comprise input field items such as “boxes” commonly presented in programs compatible with “Windows”-type operating systems, so that a user wishing to indicate acceptance of an offer can input a suitable indicator using, for example, a keyboard and/or a pointing device such as a mouse or trackball. As will be appreciated by those skilled in the relevant arts, wide variety of interactive input processes and devices are known, and will doubtless hereafter be developed.

As noted, acceptance can be full or partial. Full acceptance can be indicated by use of a yes/no indicator such as a radio-button item box 328 and/or entry of appropriate alphanumeric characters. Partial acceptance can be indicated by, for example, entering a specific currency amount, a percentage, or a fraction indicator in an input box 330, the amount typically being less than the maximum authorized for the particular credit offer.

Optionally, an indicator 306 showing a total maximum amount of credit available to the prospective debtor may be provided. As will be understood by those skilled in the relevant arts, the maximum amount(s) of credit offered to a prospective debtor may vary, depending upon the form of credit. For example, unsecured lines of credit may be associated with higher interest rates and lower maximum amounts than secured lines. Thus maximum amounts of credit shown at 324 in association with individual credit offers may not equal the maximum allowable total. For example, as shown in FIG. 3, the maximum offered in overdraft protection is $5,000, which is less than the maximum total allowable associated with the remaining credit offers.

If at 218 (shown in FIG. 2) the user has entered in fields 304 data suitable for indicating acceptance of all desired credit offers, in the desired amount(s), the user can, by issuance of a suitable input command signal as discussed above, cause one or more of processors 116, 136, and/or loan application processor 138 to process acceptance. For example, as shown in FIG. 3b, a user who has indicated full or partial acceptance of one or more displayed offers can activate an acceptance button item 310 according to known operating system protocols. This can cause the user station 302 to send to processor(s) 116, 136, 138 data signals representing the fact and amount of acceptance(s).

Acceptance of one or more offers can cause processor(s) 116, 136, 138 at 220 (shown in FIG. 2) to recalculate outstanding amounts of any residual offers, and, if any residual offers exist, at 222 to issue output signals causing the corresponding user station 102 to display an updated offer dashboard 300, as shown in FIG. 3c. Optionally, any residual credit offers presented to the prospective debtor may be accepted until the total amount of credit offered has been exhausted.

For clarity, a process suitable for implementation by any one or more of processors 116, 136, 138 in presenting an offer display screen, such as display 300 shown in FIG. 3a, according to an embodiment can be considered to begin at 206 with the processor(s) 116, 136, 138 accessing data representing data identifying the credit offer(s) to be made. As previously discussed, such offers and identifiers may be of any type suitable for use in accomplishing the purposes described herein, and may include types such as lines of credit, consumer or business loans, credit card accounts, overdraft protection, and mortgages; identifiers can include such types and information such as maximum or other amounts associated with the offers, percentage rates, and other terms. The offers may be pre-approved or may have been contemporaneously prepared, based on an active application by or on behalf of a prospective debtor.

At 216 the processor(s) 116, 136, 138 can provide to the corresponding user station 102 output signals adapted for causing the user station to present an offer dashboard display such as display 300 of FIGS. 3a-3c, comprising suitable offer identification fields 302 and acceptance input fields 304, as shown in FIG. 3a.

At 218, the processor(s) 116, 136, 138 can accept input data received from the corresponding user station 102 indicating acceptance of one or more of the displayed offers, as shown in FIG. 3b. If no acceptance is made, the system can await such acceptance while optionally offering the ability to perform other functions. If an acceptance is made, at 220 the processor(s) 116, 136, 138 can read the acceptance amount(s) and process the acceptances for further action, such as issuance of funds and/or creation of suitable credit accounts.

At 220 the processor(s) 116, 136, 138 can consider any accepted credit and re-calculate any previously-extended offers, so that if at 222 any residual credit remains, at 206 such offers may be re-extended at an appropriate level to the prospective debtor by appropriate display, as shown in FIG. 3c. The total residual amount of credit outstanding in the various offers may also be updated and displayed. For example, this re-calculation may include reducing one or more of the multiple forms of credit offered to a prospective debtor by an amount of accepted credit, so that the reduced multiple forms of credit can be presented, or offered, again to the prospective debtor. In an embodiment, the re-calculation may include accounting for the amount of credit just extended to the prospective debtor when evaluating the financial history of the prospective debtor with one or more creditors, so that any further determination of offerings of credit will account for the amount of credit just accepted by the prospective debtor. This may include adjusting an amount of credit that is considered to be acceptable risk to offer to the prospective debtor.

It will be appreciated that examination of financial history can be of a particular aspect, or aspects, of information relating to a prospective debtor.

As shown in FIGS. 3a-3c, offer display screens according to various embodiments of the invention may present a large variety of additional or alternative information and processing functionality. For example, screen 300 of FIG. 3 includes fields 306 showing a total amount of outstanding credit offers, an identifier 308 of the prospective debtor to whom the offer(s) are extended, and function items 310, 312, 314. “Complete Offers” function item 310 can cause the user station 302 to issue a command signal indicating to processor(s) 116, 136, 138 that the prospective debtor has finished with all acceptance activities, and thereby cause the processor(s) to proceed to subsequent processing of any accepted offers. Item 312 can cause the screen 300 to toggle between display of personal credit offers extended to the prospective debtor and commercial offers extended to an associated business entity. Item 314 can cause the user station to display deposits currently held by the creditor in the name or on behalf of the prospective debtor, for use, for example as security for the displayed or other credit offers.

In some circumstances, as will be appreciated by those skilled in the relevant arts, it may not be possible or advantageous to provide pre-approved credit offers to prospective debtors, or to augment any pre-approved credit offers with other offers to be applied for. For example, the making of a pre-approved offers may in general be contrary to a creditor's policy, or it may be inadvisable in respect of a given individual debtor, due for example to lack of a sufficient or acceptable credit history, or insufficient existing relationship between the prospective debtor and the creditor or third parties. In any event, if at 206 in FIG. 2 no pre-approved credit offers are identified, at 208 processor 116, working for example in cooperation with loan application server 138, can initiate a process of accessing data related to a new or pending credit application prepared by or on behalf of the identified prospective debtor.

For example, server 138 can initiate a process of presenting at the corresponding user station 102 interactive user screens adapted for the gathering of suitable data to be used in considering an application for extension of credit. Alternatively, server 138 can access existing data suitable for such use, as for example where such data has been previously collected and stored. For example, an application prepared by or on behalf of a prospective debtor may have been previously fully or partially completed; and the user can access the associated data, or useable data may have been previously collected for one or more other purposes. If required, the user can provide further data to complete a partially completed application.

When sufficient data identifying the prospective debtor and the credit request has been acquired, one or more of processors 116, 138 can process the application and initiate adjudication of a decision as to whether the creditor is willing to extend one or more credit offers, and, if so, the terms of such offer(s). As part of such an adjudication, the processor(s) 116, 138 can at 210, 212, consult either or both of internal and external credit histories related to the prospective debtors.

If the creditor by whom the credit offering(s) is being considered has a credit history of its own with the prospective debtor, at 210 the processor(s) 116, 138 may through the use of suitable signal exchanges communicate for example with server 136, and thereby with one or more of account databases 120, and/or access customer information databases 118 to assess the history of the prospective debtor with the creditor and determine whether one or more credit offerings should be made. As will be appreciated by those skilled in the relevant arts, such determinations may be based upon a wide variety of factors, including for example a financial history such as the length of the existing relationship with the prospective debtor; the amount and type of available collateral, including, for example, and deposits or accounts held by the creditor on behalf of the prospective debtor; whether, how often, and how many times the prospective debtor has failed to comply with payment or other terms of existing credit agreements, etc. Such information may be stored by one or more of databases 110 and accessed by processor(s) 116, 136, 138 in any suitable fashion.

The creditor by whom the credit offering(s) is being considered may elect to consult one or more external credit history sources 142, such as for example any of the various existing commercial credit clearing houses or credit bureau databases, such as for example Equifax or Transunion, and to acquire suitable data therefrom for use in adjudicating the loan application. As will be appreciated by those skilled in the relevant arts, such determinations may be based upon a wide variety of factors, including for example a financial history of the prospective debtor, such as the length of the prospective debtor's credit history, and whether, how often, and how many times the prospective debtor has failed to comply with payment or other terms of previous credit agreements, etc. Such information, or financial history, may be stored by one or more of data sources 110, 140 and 142, and accessed by processor(s) 116, 136, 138 in any suitable fashion.

Data and other information representing and/or otherwise relating to financial history(ies) may be retrieved from or otherwise provided by any number of current or previous creditors or other sources 110, 140, 142. As will be understood by those skilled in the relevant arts, once they have been made familiar with this disclosure, such information may, for example, be used to determine what credit offers, if any, are appropriate or otherwise desirable for offering to a prospective debtor.

When processor(s) 116, 138 have collected sufficient data, at 214 system 100 can adjudicate a decision as to whether to extend one or more credit offers. As will be appreciated by those skilled in the relevant arts, adjudication of loan applications may be made in any manner compatible with the purposes and process disclosed herein. Such decisions may be made fully automatically, using suitably-adapted processors 116, 138; manually, as for example by a human loan officer; or by any combination thereof satisfactory to the creditor. A wide variety of automated systems, including suitable computer programming exist; and many are commercially available. Doubtless a wide variety of suitable programs will hereafter be developed. Examples of such programs now commercially available include Capstone Decision Manager from Fair Isaac.

If at 214 processor(s) 116, 138 determine that one or more credit offers are to be made, at 216 processor(s) 116, 138 can cause a display offer dashboard user interface screen, such as shown in FIGS. 3a-c, to be displayed on the user station 102 from which the prospective debtor was identified, using offer display screens and processes as described above, suitably adapted for presentation and acceptance of currently-adjudicated offers in addition to or in lieu of pre-approved offers. Thus, offers displayed at 216 can include both pre-approved and currently-adjudicated offers.

Following display of any offers at 216, processing for review and, if applicable, acceptance of the offers by the prospective debtor can proceed from process stages or steps 218-222 as described above.

Thus in various aspects and embodiments the invention provides systems, methods, software and user interfaces for identification of credit opportunities, comprising pluralities of credit offers to be extended to prospective debtors by or on behalf of creditors, who may but are not required to operate or otherwise control the processors and other system components used in doing so.

While the invention has been described and illustrated in connection with preferred embodiments, many variations and modifications, as will be evident to those skilled in the relevant arts, may be made without departing from the spirit and scope of the invention. The invention is thus not to be limited to the precise details of methodology or construction set forth above. Except to the extent necessary or inherent in the processes themselves, no particular order to steps or stages of methods or processes described in this disclosure, including the figures, is implied. In many cases the order of process steps may be varied without changing the purpose, effect, or import of the methods described.

It is to be understood that the invention is described herein only in terms of strict financial or other possibility. Actual implementation of the invention may be subject to regulatory or other legal requirement(s), and no representation is made hereby that any particular embodiment complies with any regulatory or other requirement(s).

What is claimed is:

1. A system useful for automated identification of credit opportunities, comprising at least one data processor and computer programming media configured to cause the at least one data processor to:
access data representing information related to a financial history of a prospective debtor, the data provided by a plurality of sources; and
using the data, pre-approve an offering by a creditor of at least one form of credit to the prospective debtor.

2. The system of claim 1, configured to cause the at least one data processor to output data representing terms of the at least one pre-approved form of credit for review by the prospective debtor.

3. The system of claim 2, configured to cause the at least one data processor to receive response information from the prospective debtor in response to the output of the at least one of the multiple forms of credit, wherein the response information indicates at least a partial acceptance of at least a part of the at least one form of credit.

4. The system of claim 3, wherein the partial acceptance includes an acceptance of less than a full amount of credit offered.

5. The system of claim 4, configured to cause the at least one data processor to determine a further credit to be offered to the prospective debtor, based at least partly on the acceptance of less than the full amount of credit offered.

6. The system of claim 5, wherein the determining a further credit to be offered includes at least one of:
reducing credit offered by the amount of credit accepted, and
accounting for the accepted credit amount in the data used by the at least one data processor in pre-approving at least one form of credit to be further offered to the prospective debtor.

7. The system of claim 6, configured to cause the at least one data processor to output the further credit determined to be offered to the prospective debtor.

8. The system of claim 7, wherein the further credit is the amount of the credit offered reduced by the accepted credit amount.

9. A system useful for automated identification of credit sale opportunities, comprising at least one data processor associated with a creditor, and computer programming media configured to cause the at least one data processor to:
access data representing information identifying a prospective debtor;
using at least some of the accessed data, access in memory associated with the data processor data representing information related to a financial history of the prospective debtor with the creditor;
using at least some of the accessed data, access in the same or other memory data representing information related to a financial history of the prospective debtor provided by at least one other credit data source; and
using the data representing the financial history of the prospective debtor with the creditor and the data representing information related to a financial history of the prospective debtor provided by the at least one other credit data source, determine at least one form of credit to be offered by the creditor to the prospective debtor; and
output for review by the prospective debtor data representing information relating to the at least one form of credit to be offered to the prospective debtor.

10. The system of claim 9, configured to cause the at least one data processor to receive response information from the prospective debtor in response to the output of the at least one form of credit, wherein the response information indicates at least a partial acceptance of the at least one form of credit.

11. The system of claim 10, wherein the partial acceptance includes an acceptance of less than a full credit amount offered.

12. The system of claim 11, configured to cause the at least one data processor to determine a further credit to be offered to the prospective debtor, based at least partly on the acceptance of less than the full amount of credit offered.

13. The system of claim 12, wherein the determining of further credit to be offered includes at least one of:
reducing the amount of credit offered by the amount of credit accepted, and accounting for the accepted credit amount in the data used by the at least one data processor in pre-approving credit offered to the prospective debtor.

14. The system of claim 13, configured to cause the at least one data processor to output the further credit determined to be offered to the prospective debtor.

15. The system of claim 14, wherein the further credit is the at least one form of credit reduced by the accepted credit amount.

16. A system useful for automated identification of credit opportunities, comprising at least one data processor associated with a creditor, and computer programming media for causing the at least one data processor to:
access data representing information related to a financial history of a prospective debtor, the data provided by a plurality of sources; and
using at least some of the accessed data, access in the same or other memory data representing information related to a financial history of the prospective debtor with the creditor; and
using the data representing the financial history of the prospective debtor with the creditor, determine at least one form of credit to be offered by the creditor to the prospective debtor.

17. A system useful for identifying opportunities for granting of credit, comprising at least one data processor, and computer programming media for causing the at least one data processor to:
access data representing information related to a financial history of a prospective debtor, the data provided by a plurality of sources;
using the data representing the financial history of the prospective debtor, determine a plurality of forms of credit to be offered by a creditor to the prospective debtor; and
output for review by the prospective debtor data representing information relating to the plurality of forms of credit to be offered to the prospective debtor.

18. A system useful for automated processing of credit applications, comprising at least one data processor associated with a creditor, and computer programming media for causing the at least one data processor to:
access in memory associated with the data processor data representing information related to an application of an applicant for credit to be granted by the creditor;
using at least some of the accessed data, access in the same or other memory associated with the data processor data representing information related to a financial history of the applicant with the creditor;
using at least some of the accessed data, access in the same or other memory data representing information related to a financial history of the applicant provided by at least one other credit data source;
using the data representing the financial history of the applicant with the creditor and the data representing the financial history of the applicant provided by the at least one other credit data source, determine at least one form of credit to be offered by the creditor to the applicant; and
output for review by the applicant data representing information relating to the at least one form of credit to be offered to the applicant.

19. A system useful for automated identification of credit opportunities, comprising at least one data processor associated with a creditor, and computer programming media adapted to cause the at least one data processor to:
access data representing information identifying a prospective debtor;
using the accessed data, access data representing information related to a financial history of the prospective debtor provided by at least one other credit data source;
using the data representing the financial history of the prospective debtor provided by the at least one other credit data source, determine at least one form of credit to be offered by the creditor to the prospective debtor; and
output for review by the prospective debtor data representing information relating to at least one form of credit to be offered to the prospective debtor.

20. Computer programming media readable by a data processor for causing the data processor to provide output signals useful for causing a computer display to present a graphical user interface screen useable by a user in controlling the same or another data processor in an automated identification of credit opportunities, the signal causing the display screen to:
display at least one output field, the at least one output field identifying at least one of a plurality of credit offers offered by at least one creditor to a prospective debtor, whereby a plurality of credit offers offered by the at least one creditor to the prospective debtor are identified to the user of the computer display, each credit offer identified by the display of at least a type of credit and a credit amount;
display a plurality of input fields, usable by the user of the computer display in conjunction with an input device for inputting data indicating at least a partial acceptance of at least a part of one of the plurality of credit offers by the prospective debtor.

21. The computer programming media of claim 20, for further causing the same or another processor to, upon receiving input indicating the at least partial acceptance of at least a part of one of the plurality of credit offers, determine a further credit to be offered to the prospective debtor, based at least partly on the acceptance of less than a full amount of credit offered.

22. A method for identifying credit opportunities to be offered to a prospective debtor, comprising:
using information identifying a prospective debtor to access financial history information of the prospective debtor with a creditor;
using the financial history information, accessing financial history information of the prospective debtor provided by at least one other credit data source;
using the financial history information, determining at least one form of credit to be offered to the prospective debtor by the creditor; and
providing for review by the prospective debtor credit information relating to the at least one form of credit.

23. The method of claim 22, further comprising:
receiving response information from the prospective debtor in response to the providing of the at least one form of credit offered to the prospective debtor;
wherein the response information indicates at least a partial acceptance of at least a part of the credit offered to the prospective debtor.

24. The method of claim 23, wherein the partial acceptance includes an acceptance of less than a full credit amount offered.

25. The method of claim 24, further comprising considering the accepted credit amount in determining a further amount of credit to be offered to the prospective debtor.

26. The method of claim 25, wherein the determining the further credit to be offered includes at least one of:
reducing the credit offered by the accepted credit amount, and
accounting for the accepted credit amount in at least one of the financial history information and further financial history information used in determining the at least one form of credit offered to the prospective debtor.

27. The method of claim 26, further comprising outputting the further credit to be offered to the prospective debtor.

28. The method of claim 27, wherein the further credit is the amount of the credit offered reduced by the accepted credit amount.

29. Computer usable media having computer readable code embodied therein for causing at least one data processor to:
access data representing information related to a financial history of a prospective debtor, the data provided by a plurality of sources; and
using the data, pre-approve an offering by a creditor of at least one form of credit to the prospective debtor.

30. The media of claim 29, configured to cause the at least one data processor to output data representing terms of the at least one pre-approved form of credit for review by the prospective debtor.

31. The media of claim 30, configured to cause the at least one data processor to receive response information from the prospective debtor in response to the output of the at least one form of credit, wherein the response information indicates at least a partial acceptance of the at least one form of credit.

32. The media of claim 31, wherein the partial acceptance includes an acceptance of less than a full credit amount offered.

33. The media of claim 32, configured to cause the at least one data processor to output a further credit to be offered to the prospective debtor.

34. Computer usable media having computer readable code embodied therein for causing at least one data processor to:
access data representing information identifying a prospective debtor;
using at least some of the accessed data, access in memory associated with the data processor data representing information related to a financial history of the prospective debtor with the creditor;
using at least some of the accessed data, access in the same or other memory data representing information related to a financial history of the prospective debtor provided by at least one other credit data source; and
using the data representing the financial history of the prospective debtor with the creditor and the data provided by at least one other credit data source, determine a plurality of forms of credit to be offered by the creditor to the prospective debtor; and
output for review by the prospective debtor data representing information relating to the plurality of forms of credit to be offered to the prospective debtor.

35. The media of claim 34, configured to cause the at least one data processor to receive response information from the prospective debtor in response to the output of the at least one form of credit, wherein the response information indicates at least a partial acceptance of the at least one form of credit.

36. The media of claim 35, wherein the partial acceptance includes an acceptance of less than a full credit amount offered.

37. The system of claim 36, configured to cause the at least one data processor to output a further credit to be offered to the prospective debtor.

38. Computer usable media having computer readable code embodied therein for causing at least one data processor to:
access data representing information related to a financial history of a prospective debtor, the data provided by a plurality of sources; and
using at least some of the accessed data, access in the same or other memory data representing information related to a financial history of the prospective debtor with the creditor; and
using the data representing the financial history of the prospective debtor with the creditor, determine a plurality of forms of credit to be offered by the creditor to the prospective debtor.

39. Computer usable media having computer readable code embodied therein for causing at least one data processor to:
access data representing information related to a financial history of a prospective debtor, the data provided by a plurality of sources;
using the data representing the financial history of the prospective debtor, determine a plurality of forms of credit to be offered by a creditor to the prospective debtor; and
output for review by the prospective debtor data representing information relating to the plurality of forms of credit to be offered to the prospective debtor.

40. Computer usable media having computer readable code embodied therein for causing at least one data processor to:
access in memory associated with the data processor data representing information related to an application of an applicant for credit to be granted by the creditor;
using at least some of the accessed data, access in the same or other memory associated with the data processor data representing information related to a financial history of the applicant with the creditor;
using at least some of the accessed data, access in the same or other memory data representing information related to a financial history of the applicant provided by at least one other credit data source;
using the data representing the financial history of the applicant with the creditor and the data provided by at least one other credit data source, determine at least one forms of credit to be offered by the creditor to the applicant; and
output for review by the applicant data representing information relating to the at least one form of credit to be offered to the applicant.

41. Computer usable media having computer readable code embodied therein for causing at least one data processor to:
access data representing information identifying a prospective debtor;
using at least some of the accessed data, access data representing information related to a financial history of the prospective debtor provided by at least one other credit data source;
using the data representing the financial history of the prospective debtor provided by at least one other credit data source, determine a plurality of forms of credit to be offered by the creditor to the prospective debtor; and
output for review by the prospective debtor data representing information relating to the plurality of forms of credit to be offered to the prospective debtor.
